(19) United States
(12) Patent Application Publication
(10) Pub. No.: US 2022/0170853 A1
(43) Pub. Date: Jun. 2, 2022

(54) ADJUSTABLE ELECTRONIC WAVELENGTH BAND PASS SENSOR FOR SOFT X-RAY THROUGH IR SPECTRAL BANDS

(71) Applicant: Star Tech Instruments, Inc., New Fairfield, CT (US)

(72) Inventors: William C. Fricke, New Fairfield, CT (US); Mike Ganopoulos, Shelton, CT (US); Clifford A. Martin, Ithaca, NY (US); John K. Wilson, Wilton, CT (US)

(21) Appl. No.: 17/540,951

(22) Filed: Dec. 2, 2021

Related U.S. Application Data
(60) Provisional application No. 63/120,399, filed on Dec. 2, 2020.

(51) Int. Cl. G01N 21/359

(52) U.S. Cl. CPC G01N 21/359; G01N 2021/3155

(57) ABSTRACT

Exemplary aspects of the present invention are directed to a sensor that uses the spectral sensitivity of detectors, the spectral properties of optical filters, and mathematical addition and or subtraction to isolate the desired spectral band. The sensor includes a downconverter member for converting the high energy beam to easily detectable visible or NIR light, and optical filter elements and relay optics for directing the visible light to the sensing members. The sensing members transmit an electronic signal proportional to the power of the light in the passband to amplifiers wherein multiple sensing members convey optical power of selected wavelength bands through an amplifier to a microprocessor with an algorithm to determine the power in the desired band of interest and then to a displaying member. The system may be used in a vacuum, in ambient non-vacuum conditions or a purged environment. The techniques described herein can be used across the X-ray, UV, visible, near IR, IR and other electromagnetic regions to isolate desired bands.

### CROSS-REFERENCE TO RELATED APPLICATIONS

This application claims priority to U.S. Provisional Appl. No. 63/120,399 filed Dec. 2, 2020, which is hereby incorporated by reference in its entirety.

### BACKGROUND OF THE INVENTION

### 1. Field of the Invention

The present invention is directed to exemplary embodiments of a bandpass selectable optical filter for the ultraviolet (e.g., UV, DUV, EUV) through near-infrared (NIR) spectral bands. The present invention provides a stable filter not affected by ultraviolet radiation, as its responsivity does not change after many hours of exposure to ultraviolet radiation eliminating the need for frequent calibration or replacement. It can have one or more simultaneous passbands.

### 2. Related Art

There is an increased demand and need for a stable detector for various ultraviolet (e.g., UV, DUV, EUV) wavelength bands from 100-400 nm. Traditional detection systems for these regions have serious limitations. Degradation of the sensor, the bandpass filters and the optical elements, due to exposure to the highly active ultraviolet energy can result in damage and change in performance overtime. This can result in inaccurate readings and require constant re-calibration or replacement of the sensor, bandpass filters and/or other optical elements.

Various related art includes U.S. Pat. No. 4,731,811 issued Mar. 15, 1988 and entitled Narrow Spectral Bandwidth, UV Solar Blind Detector, U.S. Pat. No. 4,885,471 issued Dec. 5, 1989 and entitled Ultraviolet Radiometer, U.S. Pat. No. 6,340,820 issued Jan. 22, 2002 and entitled Near-Visible Light Detection Method and Apparatus, and U.S. Appl. Publ. No. 2005/0254122 published Nov. 17, 2005 and entitled Apparatus for Viewing and Analyzing Ultraviolet Beams, all of which are hereby incorporated by reference in their entireties.

Furthermore, there is a need for an apparatus for sensing spectral bands in the ultraviolet including but not limited to UVA, UVB and/or UVC beams wherein performance does not change or decline over time. For example, there is an important need due to use of germicidal ultraviolet lamps for sterilization applications, such as antiviral applications against SARS-CoV-2, the virus that causes COVID-19. Inaccuracies of a detector system used to monitor exposure and doses of germicidal ultraviolet energies are critical to the destruction and/or inactivation of pathogens, such as SARS-CoV-2, and inaccuracies can result in ineffective and/or improper sterilization. Exposure of current detection systems to the high energies from deep ultraviolet exposure will lead to changes in performance of the detectors, bandpass filters and other optical systems resulting in inaccuracies of the reported exposures/doses and incorrect reporting of the value and/or amount of ultraviolet exposure.

### SUMMARY OF THE INVENTION

In accordance with the present invention, the foregoing objects and advantages have been readily attained.

The present invention is directed to a sensor for one or more ultraviolet wavelength regions, such as the EUV, XUV and/or soft X-ray regions, which is not degraded by ultraviolet exposure, without the use of optical bandpass filters and therefore results in an improved long-term accuracy without the need for frequent sensor recalibrations or replacements.

The sensor uses the spectral sensitivity of detectors, the spectral properties of optical filters and mathematical addition and/or subtraction to isolate the desired spectral bands.

It is an object of the present invention to provide a sensor that does not rely upon bandpass filters that can change with exposure to ultraviolet energies.

According to an exemplary aspect of the invention, a single discrete sensor or a series of sensors for various ultraviolet wavelength bands, which may include downconverter member(s) for converting the ultraviolet beam to easily detectable light (e.g. visible or near infrared (IR) light); and a sensing member for measuring the power of the visible light thereon; and relaying the visible light to the sensing member(s); wherein the signal from the sensing member(s) is transmitted to the displaying member for conveying information regarding the power of the visible/IR light to the beam power display member.

The invention relates to a high accuracy sensor(s) for one or more ultraviolet wavelength regions, such as EUV, XUV and/or UV, referred to as ultraviolet bands (collectively referred to as beams), which accurately and reliably produces power information of the beam without performance degradation due to long-term exposure to UV radiation. As used herein, the term “beam” refers to any ultraviolet wavelength region, such as EUV, DUV or X-ray source.

In accordance with the present invention, the beam is downconverted to longer wavelength radiation (visible, near-IR, etc., hereinafter collectively referred to as visible light) and relayed to a sensor and then conveyed through the amplifier to the microprocessor which separates the signals into the desired band or bands, calculates the power within those bands by measuring the signal on the detectors and then subtracts or adds the signal from a reference channel to get the power or energy in the in the desired band or bands, and relays that information to the displaying member. In this manner, the sensing member is not exposed directly to the incident ultraviolet beam, and is therefore protected from same. Selection of the wavelength selective materials is important to the longevity of the system. Preferably, materials may be selected that are not adversely affected by ultraviolet exposure. The sensor elements are not exposed or only subject to very minor exposure to ultraviolet light, and thereby are not subject to the degradation and changes that other systems experience.

In accordance with an exemplary aspect of the present invention, a power sensor for a beam is provided that may include a downconverter for converting the beam to visible light, one or more detectors for sensing an power of the visible light thereon, and where each of the one or more detectors may be a band specific detector and in communication with the other band specific detectors for conveying information regarding comparative power of the visible light in multiple channels to the other band specific detectors.

In accordance with the above and other exemplary aspects of the present invention, the one or more detectors may be a silicon detector or other sensor configured to detect the energy in the emission spectrum of the resulting energy from the downconverter.

In accordance with the above and other exemplary aspects of the present invention, an algorithm is used to separate multiple channels to calculate the desired resulting band(s) of interest.

In accordance with the above and other exemplary aspects of the present invention, the algorithm may be implemented by one or more processors of a processing system executing software. The software may include one or more sets of executable instructions stored or otherwise tangibly embodied on a non-transitory computer readable storage medium. The software can include the instructions and certain data that, when executed by the one or more processors, manipulate the one or more processors to perform one or more aspects of the algorithm above.

In accordance with the above and other exemplary aspects of the present invention, the bands of interest may be one or more of UVA (315 to 400 nm), UVB (280 to 315 nm), UVC bands (100 to 280 nm) and/or EUV (10 to 121 nm).

In accordance with the above and other exemplary aspects of the present invention, electronic subtraction or addition of individual channels from a reference channel result in the band of interest.

In accordance with the above and other exemplary aspects of the present invention, the number of channels can be any number N plus reference channel N+1.

In accordance with the above and other exemplary aspects of the present invention, the power sensor may also be configured to measure the power/energy in the visible or NIR bands and correlate that measurement to the power in the UV beam.

### BRIEF DESCRIPTION OF THE SEVERAL VIEWS OF THE DRAWINGS

For a fuller understanding of the nature and object of the present invention, refer to the following detailed description taken in connection with the accompanying drawings, in which:

FIGS. 1 and 2 show schematic illustrations of exemplary sensor apparatus according to the present invention.

### DETAILED DESCRIPTION OF THE INVENTION

The present invention now will be described more fully hereinafter with reference to the accompanying figures, in which exemplary embodiments of the invention are shown. The invention may, however, be embodied in many different forms and should not be construed as limited to the embodiments set forth herein. Like reference numerals refer to like elements throughout.

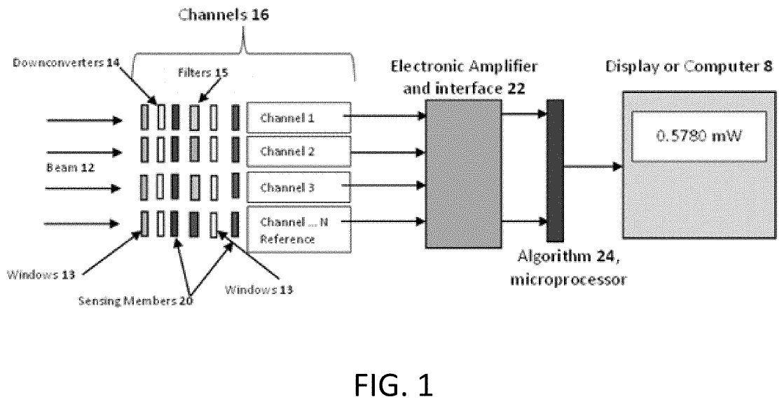

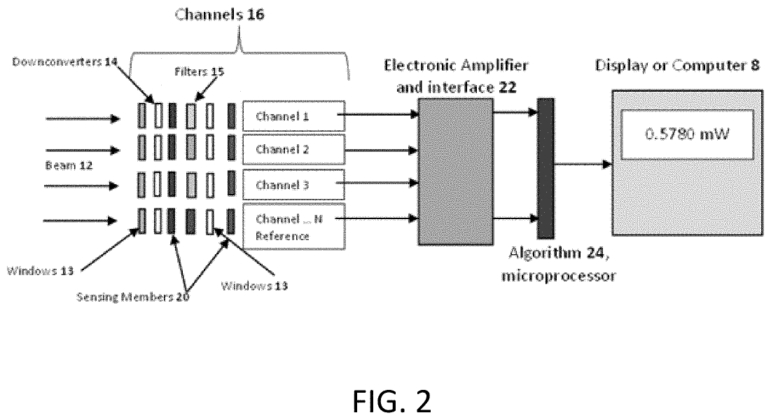

Referring now to FIGS. 1 and 2, therein illustrated are schematics of exemplary apparatuses, which may be sensors, according to an aspect of the present invention. The sensor according to the present invention includes one or more downconverters 14 which advantageously converts the ultraviolet beams 12, which may be beams from one or more of the ultraviolet wavelength bands, such as UVA, UVB and/or UVC, to visible or IR light, optional vacuum window 13, optical filters 15 with selective band-passes, may be combined with relay optics along two or more channels 16, which are advantageously conveyed to detectors 20 (sensing members) such as a silicon or other types of detectors. The sensor includes the one or more downconverters 14 for converting the beam 12 to easily detectable visible or near IR light. The optical filters 15 and relay optics direct the visible or near IR light to the detectors 20. The detectors 20 then transmit an electronic signal proportional to the intensity of the light in the desired passband to an electronic amplifier and interface 22, which then conveys the electronic signal to a microprocessor 24 containing an algorithm and configured to perform with program code on a non-transitory computer readable medium a mathematical procedure that compares the signals from channels 1, 2 and/or 3 and calculates the desired signals, and results in the power in the desired bands and conveys resulting values from detectors 20, which is advantageously communicated through suitable electronics 22, so as to provide information or feedback as desired to display 8. The sensor may be used in a vacuum, in ambient non-vacuum conditions or in a purged environment.

For example, for a 3-channel calculation plus reference channel the use of multiple detectors with differing band passes allows for addition and subtraction of the values electronically. As a result, bandpasses are selected by either subtraction or adding the signals together to get a full range. This is especially useful to the method when measuring discrete bands such as UVA, UVB and UVC and compare them to a reference signal. An exemplary equation of this calculation is provided below:

[(N+1(Ref))−(N1+N2)=N3]

It is understood that the apparatus in accordance with the present invention advantageously avoids direct incidence of ultra-violet beams 12 on detectors 20, which, as set forth above, would rapidly damage or destroy or change the sensitivity of detectors 20. Rather, beam 12 is advantageously converted to visible or near IR light and incident on detectors 20 such that the power of the visible light on detectors 20 can be detected, and correlated to the power of beam 12, so as to advantageously provide accurate, and long-term, reliable, information regarding power of beam 12 in multiple channels 16.

It should be noted that the display 8, vacuum window 13, downconverter 14, optical filter 15, detector 20, amplifier 22 and microprocessor 24 are all devices which themselves are well known to a person of ordinary skill in the art. Further the conveyance of the light energy collected from the downconverter may be collected with fiber optics, or lenses or other optical transfer devices and then relayed to a sensing detector.

This apparatus, in addition to general UV, germicidal, UVC, UVB and UVA applications, can advantageously be used in numerous industrial, medical and like procedures wherein the accurate power of UV beams is critical and the long-term degradation of the monitoring sensor can result in inaccuracies that could be harmful or undesirous. Specific examples of various applications wherein the apparatus of the present invention can find useful application include band specific power monitoring in: water purification, sanitization, solar power, (UVA, UVB, UVC), germicidal, bilirubin (jaundice, therapy), tanning bed lamps, and the like.

It is understood that while discussion was directed to the XUV and UV regions, the techniques and sensor described herein can be used across the X-ray, UV, visible, near IR, IR and other electromagnetic regions to isolate desired bands.

In accordance with various embodiments of the present invention, certain aspects of the invention may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

It will thus be seen that the objects set forth above, among those made apparent from the preceding description, are efficiently attained and, since certain changes may be made in the above article without departing from the scope of this invention, it is intended that all matter contained in this disclosure or shown in the accompanying drawings, shall be interpreted, as illustrative and not in a limiting sense. It is to be understood that all of the present figures, and the accompanying narrative discussions of corresponding embodiments, do not purport to be completely rigorous treatments of the invention under consideration. It is to be understood that the above-described arrangements are only illustrative of the application of the principles of the present invention. Numerous modifications and alternative arrangements may be devised by those skilled in the art without departing from the scope of the present invention.

What is claimed is:

1. A power sensor for a beam, comprising:
a downconverter for converting the beam to visible light;
one or more detectors for sensing an power of the visible light thereon;
wherein each of the one or more detectors is a band specific detector and in communication with the other band specific detectors for conveying information regarding comparative power of the visible light in multiple channels to the other band specific detectors.

2. The power sensor according to claim 1, wherein the one or more detectors are a silicon detector or other sensor configured to detect the energy in the emission spectrum of the resulting energy from the downconverter.

3. The power sensor according to claim 1, wherein an algorithm is used to separate multiple channels to calculate the desired resulting band(s) of interest.

4. The power sensor according to claim 3, wherein the bands of interest are one or more of UVA, UVB, UVC bands.

5. The power sensor according to claim 3, wherein electronic subtraction or addition of individual channels from a reference channel result in the band of interest.

6. The power sensor according to claim 5, wherein the number of channels can be any number N plus reference channel N+1.

7. The power sensor according to claim 1, wherein the power sensor is further configured to measure the power/energy in the visible or NIR bands and correlate that measurement to the power in the UV beam.
